(19) United States
(12) Patent Application Publication
(10) Pub. No.: US 2004/0046529 A1
(43) Pub. Date: Mar. 11, 2004

(54) Appliance for protecting a boat generator and for synchronisation

(76) Inventors: Jens Kahle, Norderstedt (DE); Bernd Kallbach, Oststeinbek (DE); Hans-Peter Willer, Jesteburg (DE)

Correspondence Address: HARNESS, DICKEY & PIERCE, P.L.C., P.O.BOX 8910, RESTON, VA, 20195, US

(21) Appl. No.: 10/470,914

(22) PCT Filed: Jan. 22, 2002
(86) PCT No.: PCT/DE02/00196

(30) Foreign Application Priority Data
Feb. 1, 2001 (DE) 10104893.9

(51) Int. Cl. H02H 7/06; H02P 9/00

(52) U.S. Cl. 322/17

(57) ABSTRACT

The invention relates to an appliance for protecting a boat generator and for synchronisation. The values of the generator are measured in an analogue manner and are digitally evaluated.

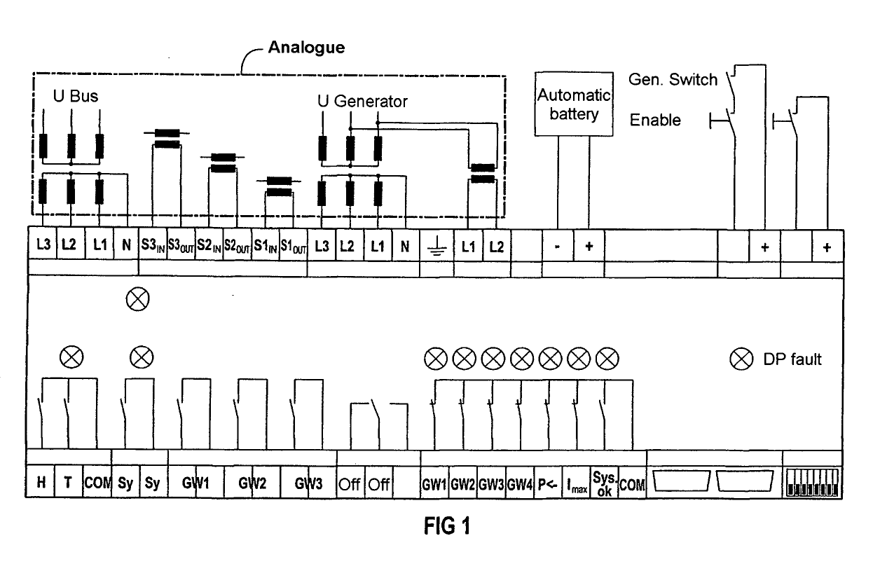

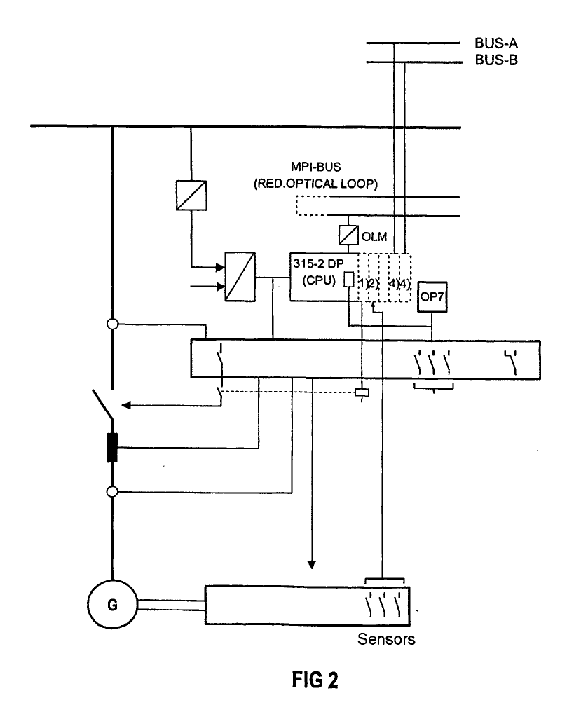

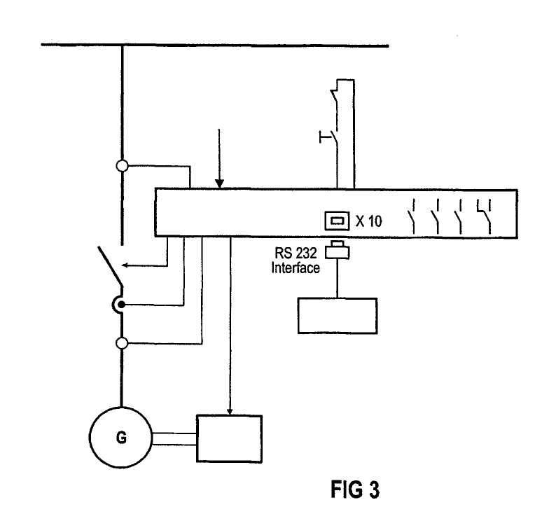

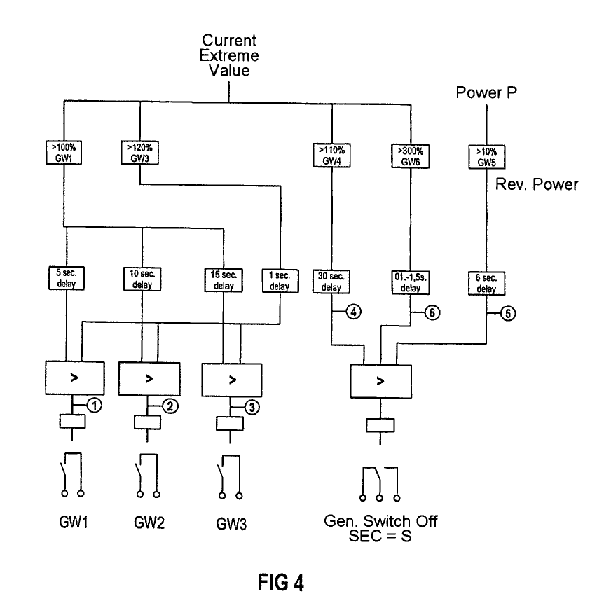

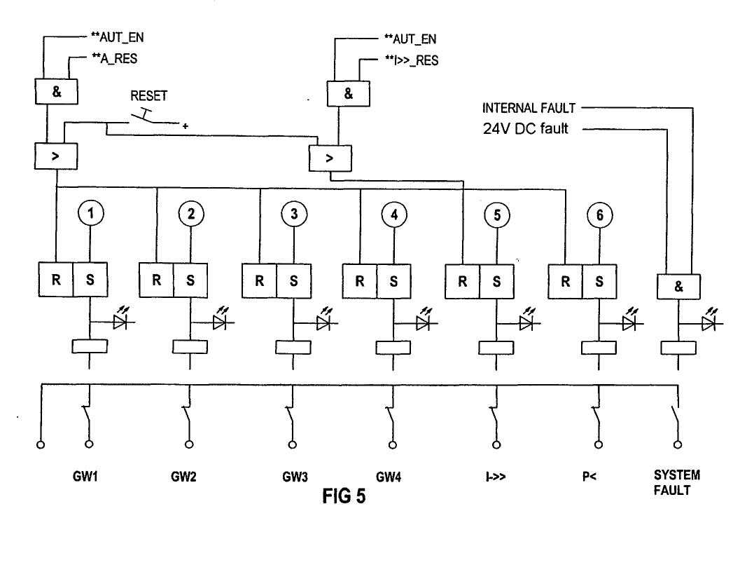

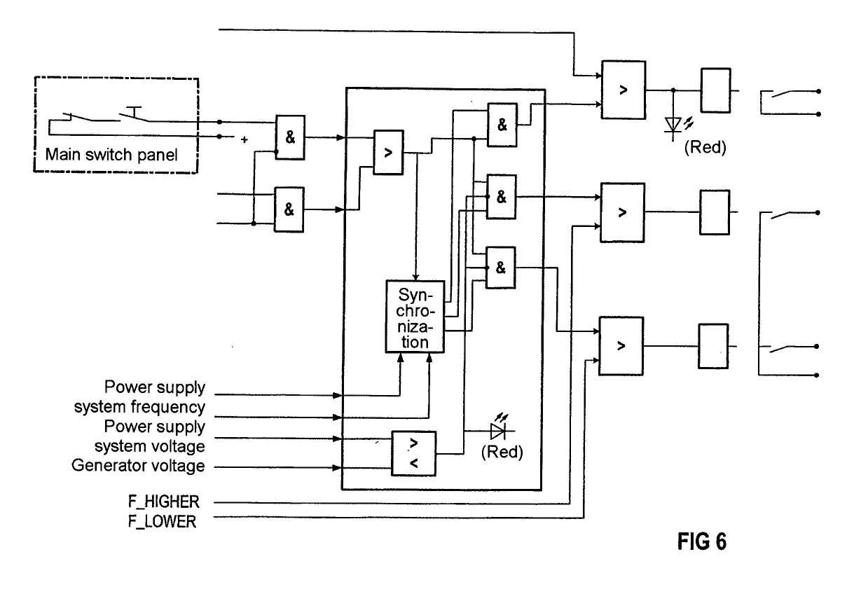

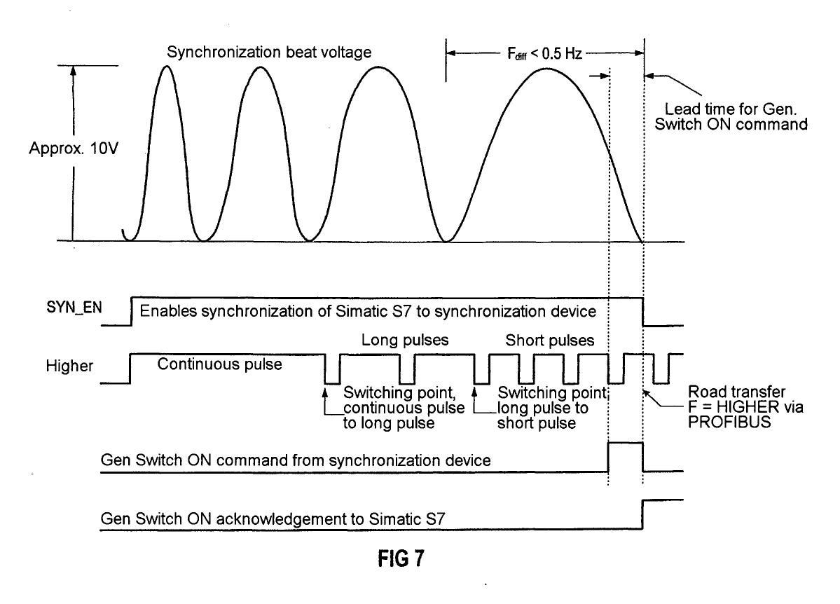

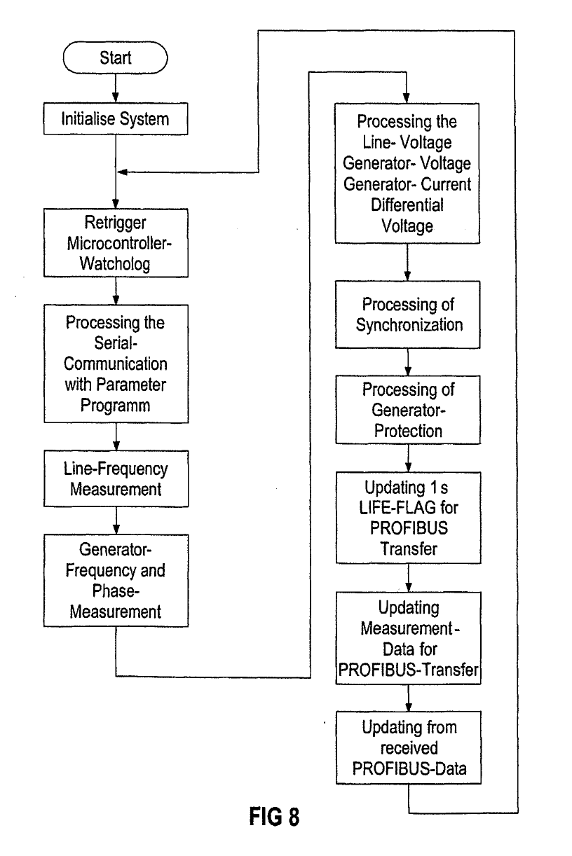

The invention relates to a marine generator protection and synchronization device which records the generator values in analogue form.

Since it is simple to record generator values in analogue form, it has until now been normal to use generator protection and synchronization devices which operate in analogue form on marine vessels.

The object of the invention is to specify a generator protection and synchronization device which can be configured more easily and can be adjusted more accurately than was known until now. The object is achieved by digitization which is based on values determined in analogue form.

Further embodiments of the invention, which are also inventive, can be found in the dependent claims, in the drawings and in the description. The drawings are provided with conventional electrical engineering symbols, so that those skilled in the art can see the electrical engineering aspects of the design of the device according to the invention without any problems.

The generator protection and synchronization device provides generator protection with the following functions:

Short-circuit detection

Monitoring for over current in each phase

Monitoring for reverse power

Disconnection of unimportant loads

Automatic synchronization of the generator to the busbar

Recording, processing and transfer of various measurement values via a bus, in particular a Profibus.

The three generator currents IL1, IL2, IL3 are recorded via measurement transducers for generator protection. The extreme values of the three currents are monitored against limit values.

The generator protection function that is described by way of example is shown in the following table:

Generator Current

| | | | | | | Relay |
|---|---|---|---|---|---|---|
| | | Delay | | | | Gen. |
| Limit | | time | Relay | Relay | Relay | Switch |
| value | 1 in % | second | GW1 | GW2 | GW3 | off |
| GW1 | 100 | 5 | X | | | |
| | | 10 | | X | | |
| | | 15 | | | X | |
| GW3 | 120 | 1 | X | X | X | |
| GW4 | 110 | 30 | | | | X |

Reverse Power

| | | | | | | Relay |
|---|---|---|---|---|---|---|
| | | Delay | | | | Gen. |
| Limit | | time | Relay | Relay | Relay | Switch |
| value | 1 in % | second | GW1 | GW2 | GW3 | off |
| GW5 | 0-100 | 6 | | | | X |

Short Circuit

| | | | | | | Relay |
|---|---|---|---|---|---|---|
| | | Delay | | | | Gen. |
| Limit | | time | Relay | Relay | Relay | Switch |
| value | 1 in % | second | GW1 | GW2 | GW3 | off |
| GW6 | >300 | 0.1- | | | | X |
| | | 1.5 | | | | |

The defect message signals which occur in the context of generator protection are maintained until they are acknowledged by the high-level controller, or are cancelled by the RESET. The failure of the 24-V battery voltage or a defect in the computer necessarily result in signaling by tripping of the “system fault” relay.

Frequency adjustment is carried out for synchronization. Once the machine set has been started, it is made to approach the power supply system frequency,

firstly with a continuous adjusting command and then with long pulses and short pulses. The comparison as to whether the power supply system frequency is greater than or less than the generator frequency is also carried out in the generator protection and synchronization device.

If the generator frequency is <the power supply system frequency, the signal “1” appears at the output “HIGHER”.

If the generator frequency is >the power supply system frequency, the signal “1” appears at the “LOWER” output.

The length of the HIGHER/LOWER adjusting pulses can be varied on the control panel.

The beat voltage which is obtained from the synchronization device is advantageously evaluated for synchronization of the generator switch. The beat voltage is produced by comparing the power supply system voltage and the generator voltage. The gradient of the beat voltage varies as a function of the difference between the generator frequency and the power supply system frequency. The gradient of the beat voltage curve as obtained from the measurement values is evaluated, and the switch-on command is produced with the appropriate lead.

| Generator/busbar | |
|---|---|
| n difference frequency (HZ) | Lead time max. (ms) |
| 0.2 | 456 |
| 0.3 | 276 |
| 0.4 | 192 |
| 0.5 | 204 |
| 0.6 | 146 |
| 0.7 | 128 |
| 0.8 | 88 |
| 0.9 | 60 |
| 1.0 | 58 |

The difference frequency between the power supply system frequency and the generator frequency is likewise derived from the beat voltage. If the difference frequency is >0.5 Hz, the synchronization is inhibited. If the difference frequency is >10 Hz, the HIGHER/LOWER adjusting pulses are inhibited entirely, since there must be a machine set fault in this case.

If the generator frequency is made to approach the power supply system frequency very closely by means of adjusting command, such that continuous beating occurs (power supply system and generator frequencies are the same), then an adjusting pulse is given and a greater Delta-f is produced, in order to allow faster synchronization. The zero crossings of the beating are evaluated for this purpose. If no zero crossing occurs in the beating within a specific time, then another adjusting pulse is produced.

The following values can advantageously be set:

Limit value of the difference frequency for enabling the adjusting pulses (for example 10 Hz)

Limit value of the difference frequency for switching from continuous pulse and long pulse (for example 1.5 Hz)

Limit value of the difference frequency for switching from long to short pulse (for example 0.6 Hz)

Limit value of the difference frequency for switching on the generator switch at the zero crossing (for example 0.5 Hz)

Pulse length of the short pulses

Pulse length of the long pulses

Lead time before reaching the zero crossing of the beat voltage (switch-on time for the generator switch)

Pulse length of the switch-on command for the generator switch

Delay time for initiating frequency tuning

Pulse length of the “HIGHER/LOWER” pulses for frequency tuning

Limit value for the difference between the generator voltage and the power supply system voltage for inhibiting the adjustment and for connection of the generator switch.

The connection of the generator switch is blocked if the voltage difference is too great. If the voltage difference is greater than a limit value which can be set, then the connection of the generator switch and the outputting of the adjusting pulses are inhibited. The fact that the limit value has been exceeded is signaled by means of an LED on the front face of the device. A voltage regulator can optionally be provided in the SIMATIC-S7, and emits higher/lower adjusting pulses to the voltage regulator of the generator.

1. A marine generator protection and synchronization device, characterized in that the generator values are recorded in analogue form and are then digitized.

2. The marine generator protection and synchronization device as claimed in claim 1, characterized in that the generator values are measured by means of sensors with analogue/digital converters.

3. The marine generator protection and synchronization device as claimed in claim 1 or 2, characterized in that the generator values are transmitted in the form of digital data via a data bus, for example a Profibus, which is preferably redundant and in particular advantageously operates optically.

4. The marine generator protection and synchronization device as claimed in claim 1, 2 or 3, characterized in that the generator is controlled and regulated digitally.

5. The marine generator protection and synchronization device as claimed in claim 1, 2, 3 or 4, characterized in that the generator is protected via components which operate digitally.

6. The marine generator protection and synchronization device as claimed in one or more of the preceding claims, characterized in that the device has a configuration program.

7. The marine generator protection and synchronization device as claimed in one or more of the preceding claims, characterized in that the device is a stand-alone device.

8. The marine generator protection and synchronization device as claimed in one or more of the preceding claims, characterized in that the connections of the device are designed such that it can be used to replace analogue generator protection and synchronization devices for all conventional generators.

9. The marine generator protection and synchronization device as claimed in one or more of the preceding claims, characterized in that the device can be used as a generator protection and synchronization device for generators with permanent-magnet excitations.

10. The marine generator protection and synchronization device as claimed in one or more of the preceding claims, characterized in that the device can be configured via a PC.

11. The marine generator protection and synchronization device as claimed in one or more of the preceding claims, characterized in that the device can be integrated in a marine vessel propulsion system.
